(19) United States
(12) Patent Application Publication
(10) Pub. No.: US 2016/0267814 A1
(43) Pub. Date: Sep. 15, 2016

(54) Cookie Chemistry Lab Kit

(71) Applicant: Crystal Alicia Felton, Athens, TN (US)

(72) Inventor: Crystal Alicia Felton, Athens, TN (US)

(21) Appl. No.: 14/881,637

(22) Filed: Oct. 13, 2015

Related U.S. Application Data
(60) Provisional application No. 62/130,407, filed on Mar. 9, 2015.

(51) Int. Cl. G09B 23/24; A21D 13/08

(52) U.S. Cl. CPC G09B 23/24; A21D 13/08

(57) ABSTRACT

A novelty kit comprising components which represent tools for preparing and baking cookies where a user can observe, analyze, and comprehend the physical changes and chemical reactions that occur in such a process. The novelty kit, or educational tool, includes an instruction set where multiple baking scenarios are disclosed. Each baking scenario may include creating multiple batches of cookies wherein each batch utilizes the same ingredients in the same proportion while substituting one ingredient for another. By substituting the one ingredient, where all other ingredients remain the same, the user can identify and observe the repercussions of the substitution in a tangible manner thereby educating the user with regards to the basic principles of chemistry and cause-and-effect in an experimental and fun setting.

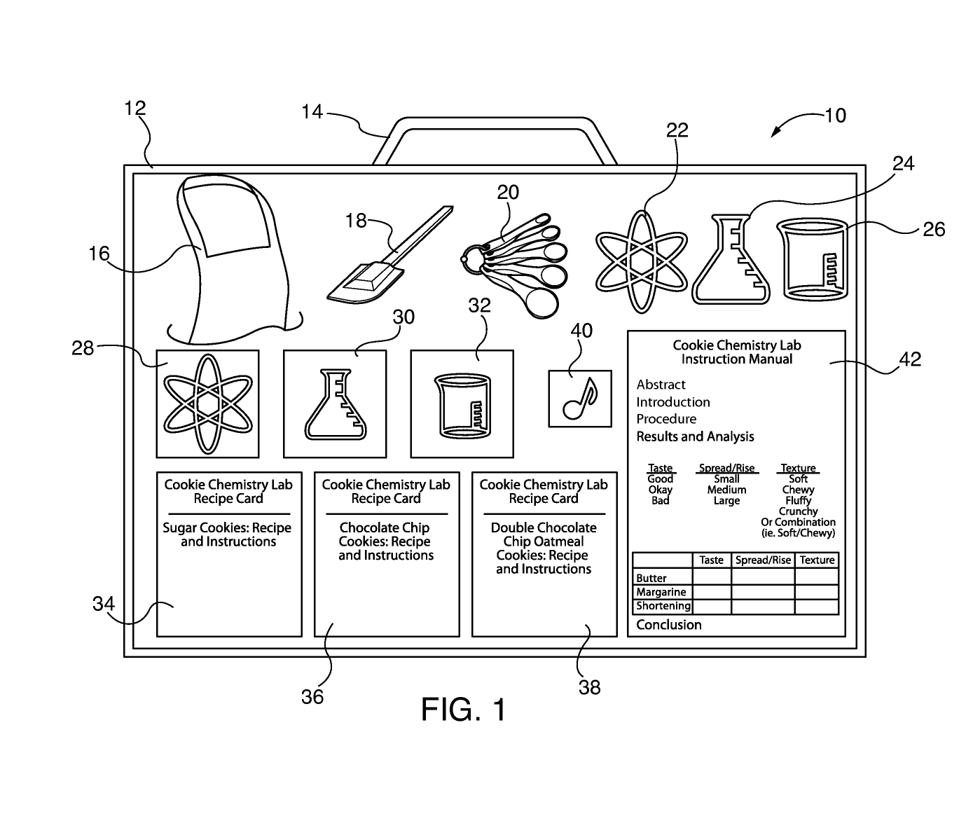

### CROSS-REFERENCE TO RELATED APPLICATIONS

This application claims priority to U.S. Application No. 62/130,407, filed Mar. 9, 2015, which is hereby incorporated by reference in its entirety.

### FIELD OF THE INVENTION

The present invention relates to a novelty kit which presents physical supplies to enable a user to perform and observe the chemical reactions and physical changes associated with, and corresponding to, the process of baking cookies.

### BACKGROUND OF THE INVENTION

The process of teaching chemistry is difficult and complex, as a result, we often utilize experimentation to identify observable reactions and results within the realm of teaching chemistry. One such experiment, namely baking cookies, can successfully demonstrate a multitude of chemical reactions and physical changes that occur both simultaneously and in succession in a fun and novel manner. Presently, there is a lack of suitable instruments to teach users, more particularly children, the science of said chemical reactions and physical changes in a fun, comprehensible, and safe manner.

### SUMMARY OF THE INVENTION

The present invention meets the needs presented above by generally comprising a receptacle including a bottom wall and a perimeter wall being attached to and extending upwardly from the bottom wall. The perimeter wall has an upper edge defining an opening extending into an interior space of the receptacle which contains a novelty kit for teaching one or more users the chemical reactions and physical transformations that occur in the process of preparing and baking cookies by utilizing any one of a plurality of baking scenarios including a first baking scenario, a second baking scenario, and a third baking scenario.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

The objects of the invention, along with the various features of novelty which characterize the invention, are pointed out with particularity in the claims annexed to and forming a part of this disclosure.

It is an object of the invention to provide improved elements and arrangements thereof by apparatus for the purposes described which is inexpensive, dependable, and fully effective in accomplishing its intended purposes.

These and other objects of the present invention will become readily apparent upon further review of the following specification and drawings.

### BRIEF DESCRIPTION OF THE DRAWINGS

Various objects, features, and attendant advantages of the present invention will become more fully appreciated as the same becomes better understood when considered in conjunction with the accompanying drawing which is a side view of an exemplary kit in accordance with the present invention.

### DETAILED DESCRIPTION

Referring to Drawing, according to at least one aspect of the invention, there is shown a novelty kit 10 intended to enable a user to perform, observe, and document the chemical reactions and physical changes associated with, and corresponding to, the process of baking cookies, for educational purposes, by utilizing any one of a plurality of baking scenarios including a first baking scenario, a second baking scenario, and a third baking scenario. Any number of scenarios may be provided for, including only one. However, the present example will illustrate three baking scenarios.

It is contemplated that the novelty kit 10 will be used as an educational tool, namely for children in conjunction with adult supervision, to learn the underlying science and chemistry associated with, and corresponding to, that of baking cookies. The novelty kit 10 also exposes the user to the fundamental aspects of performing scientific experimentation in a fun setting, for example, how to identify dependent and independent variables; how such variables change at both a physical and chemical level; how to mix various ingredients; how to follow a lab manual or an instruction set similar thereto; how to identify physical and chemical changes in chemical compositions; how to examine and analyze results; how to gather data and annotate such data; how to analyze results while comparing said results to the data gathered; and the like.

It is contemplated that each scenario is equivalent to an experiment. To further illustrate, each experiment or baking scenario may be performed to observe the chemical and physical changes that take place when baking cookies when a user changes an ingredient, such as fat, when all other ingredients remain the same and in equal proportion. To further elaborate, when baking cookies, utilizing different fats—butter, margarine, or shortening—will yield different tangible, intangible, and observable results in the cookies prepared in such a manner. The type of fat used when baking cookies can bring forth a different result in texture, spread, taste, and the like of the cookie allowing a user to observe the physical and chemical changes when supplanting one ingredient for another where all other variables, or ingredients, remain equal and/or the same. To observe these differences in the novelty kit 10 a user will use a general recipe for each batch of cookies such that only the fat being utilized will be changed. As a result of different fats being used, the user can observe the different results with regards to the end result of the cookies prepared when utilizing different independent and dependent variables.

Illustratively, in the instant invention, an independent variable is the variable that the experimenter changes on purpose, or in this case, the user. Moreover, the dependent variable is the variable that changes in response to the independent variable. It is to be appreciated that in the present invention, the independent variable may be the type of fat being used, which, as previously mentioned, may be butter, margarine, or shortening. As such, the dependent variable is the texture, spread, and taste of the cookie which is observed for the response to the independent variable. However, in alternate embodiments the independent variable may be another ingredient vital to the baking of cookies, such as, baking soda, baking powder, unsalted butter, salted butter, and the like.

In an illustrative embodiment, the first baking scenario consists of a user baking three batches of the same type of cookie wherein each batch utilizes the same ingredients—except for the fat being used. One batch may utilize butter, another batch may utilize melted shortening, and the third batch may utilize margarine. To this end, the novelty kit 10 may include a first indicia 34, a second indicia 36, and a third indicia 38 whereby the first indicia 34 may provide an ingredient list and directions for preparing and baking sugar cookies. The second indicia 36 may provide an ingredient list and directions for preparing and baking chocolate chip cookies. In addition, the third indicia 38 may provide an ingredient list and directions for preparing and baking double chocolate chip oatmeal cookies. It is contemplated that any number of cookie recipes may be disclosed in the first indicia 34, the second indicia 36, and the third indicia 38. It is further contemplated that each baking scenario will utilize the same ingredients whereby only one ingredient will be substituted to enable observable differences with respect to the results in texture, spread, and taste of the cookies prepared in such a manner.

Furthermore, the first baking scenario may comprise a user cooking three batches of sugar cookies by utilizing the following ingredients, for the first batch, predicated on the first indicia 34: 3 cups of all-purpose flour; ¾ teaspoon of baking powder; ½ teaspoon of salt; 1 cup of unsalted softened butter (acting as the fat and independent variable in the first baking scenario); 1 cup of sugar; 1 egg which has been beaten; 1 tablespoon of milk; and 2 tablespoons of powdered sugar for rolling out dough. Next, the user may prepare a mixture of the foregoing ingredients in the same quantity while supplanting the 1 cup of unsalted softened butter with melted shortening for the second batch of cookies. Thereafter, the user may prepare a third batch of cookies utilizing the foregoing ingredients, however, as noted above, the fat utilized will not be butter or melted shortening, rather, the fat to be utilized may be margarine. The user may be afforded cooking directions provided by the first indicia 34, the second indicia 36, and the third indicia 38.

The novelty kit 10 may provide a first set of objects which is thematically linked to the first cooking scenario such that multiple instruments to assist the user in preparing the cookies may be afforded. Illustratively, the user may utilize an apron 16 when implementing the first baking scenario and preparing the initial ingredients. The apron 16 may display different designs, patterns, and logos to humorously encourage the user in the context that baking and chemistry are fun and educational. Further, the user may utilize a spatula 18 to assist with mixing the aforementioned ingredients. In determining the correct quantity of ingredients per each baking scenario, the novelty kit 10 also provides for a measuring spoon 20, however, it should be noted that the in the present invention various measuring devices may be used to ascertain the appropriate quantity of each respective ingredient. Moreover, the novelty kit 10 may further include three cookie cutters in various shapes such that cookie cutters 22, 24, and 26 pertain, respectively, to an atom, a beaker, and a flask, to allow the user to design various shapes of the cookies in order to reinforce the notion that chemistry and cooking are fundamentally intertwined, and more importantly, fun. In this regard, stencils 28, 30, 32 may be provided by the novelty kit 10 whereby each respective stencil pertains to an atom, a beaker, and a flask, which will assist the user in decorating the cookies prepared in each baking scenario when using sprinkles or other toppings for cookies.

A second baking scenario may be predicated on the second indicia 36 wherein the ingredients are as follows: 2¼ cups of all-purpose flour; 1 teaspoon of baking soda; 1 teaspoon of salt; 1 cup (2 sticks) of softened butter; ¾ cup of granulated sugar; ¾ cup packed brown sugar; 1 teaspoon vanilla extract; 2 large eggs; and 2 cups of chocolate morsels. It is further contemplate that a user may prepare two batches of chocolate chip cookies, in the second baking scenario, utilizing the ingredients above such that all the ingredients are the same and in equal proportion—except that one batch will utilize baking soda, whereas the other will use baking powder. As such, the user can experiment and observe that baking powder will give the cookie a doughier, less desirable taste, while baking soda gives the cookies a more appetizing taste. What's more, the user may learn that baking powder and baking soda are both leavening agents and cause the formation of carbon dioxide to make the batter rise. The user may further learn that since baking powder contains both an acid and a base it gives a more neutral taste in effect to the recipe, while baking soda is basic and will typically yield a bitter taste unless countered by the acidity of another ingredient.

A third baking scenario may be predicated on the third indicia 38 wherein the user may prepare two batches of double chocolate chip oatmeal cookies such that all the ingredients are the same and in equal proportion—however, the user may utilize salted butter in one batch and unsalted butter in the other. As such, the user can experiment and observe that cookies may be too salty when salted butter is used in such a recipe and that unsalted butter generally affords a more consistent result and flavor. The third indicia 38 may disclose ingredients such as: 3 cups of all-purpose flour, 1 teaspoon of baking powder, 1 teaspoon of baking soda, ½ teaspoon salt, 3 sticks of softened unsalted butter, 1½ cups of granulated sugar, 1½ cups packed light brown sugar, 2 eggs, 1 tablespoon vanilla extract, 1½ cups of rolled oats, 1 cup semi-sweet chocolate chips, and 1 cup of milk chocolate chips.

In keeping with the intended humorous element of the novelty kit 10, the novelty kit 10 may include a temporary tattoo 40 which may further utilize different images. In the present example, the temporary tattoo 40 resembles a musical note. The novelty kit 10 may be enclosed within a receptacle 12 which may have a carrying handle 14 for example. The first, second, and third baking scenarios may include any one of a plethora of cookie recipes which have been popularized in cook books and electronic media. To that end, the novelty kit 10 may further provide a first instruction set 42 which may take the form of an instruction manual which may further also act as a lab or experiment manual which provides not only instructions with respect to implementing the baking scenarios/experiments but also charts, figures, graphs, and the like for annotating data, results, observations, and the like. Any number of instruction sets may be provided for, including only one. However, the present example will illustrate one instruction set.

One illustration of instructions have been described, above, in a representative capacity, however, it should be noted that such instructions may also take the form of a compact disc, dvd, Blu-ray, downloadable content from the Internet, and other digital forms. The instruction set 42 may be expanded to include hypothetical questions. Moreover, it is contemplated that the instruction set 42 may also be expanded to incorporate “fun facts,” such as the following:

(1) Mixing ingredients in the bowl is called a “Physical Change.” A physical change does not change the chemical composition of a substance.

(2) Baking cookie dough is called a “Chemical Change.” Chemical Changes take place when a substance combines with another to form a new substance. When baking soda (sodium bicarbonate), NaHCO₃, heats up it causes a chemical reaction to produce CO₂ (carbon dioxide), which forms bubbles in the dough.

(3) Sugar, or sucrose, is common table sugar and is hygroscopic. This means that it take up and retains moisture (water, H₂O). As a result, its chemical bonding properties create a crisper, flatter cookie because it absorbs moisture from the mixture. White sugar chemical structure is C₁₂H₂₂O₁₁.

(4) Eggs are binders which combines with the rests of the ingredients and holds them together. They also act as a leavening agent which will soften and moisten the cookie.

(5) Flour combines with water to form gluten which provides structure for the cookie.

(6) Fat (butter and margarine) encourages thinning and spreading of the cookie making it flavorful.

(7) Salt (NaCl) adds flavor to the cookie.

The foregoing is an example of the content that may be disclosed in the first instruction set 42, however, in alternate embodiments the chemical compositions and chemical equations of each ingredient may be disclosed. In an alternate embodiment, the resulting chemical compositions and chemical equations of mixing certain ingredients may further be disclosed in the first instruction set 42.

While the present invention has been described in connection with what is considered the most practical and preferred embodiment, it is to be understood that the present invention is not to be limited to the disclosed arrangements, but is intended to cover various arrangements which are included within the spirit and scope of the broadest possible interpretation of the appended claims so as to encompass all modifications and equivalent arrangements which are possible.

I claim:

1. A novelty kit for teaching one or more users the chemical reactions and physical transformations that occur in the process of preparing and baking cookies by utilizing any one of a plurality of baking scenarios including a first baking scenario, a second baking scenario, and a third baking scenario, comprising:
a receptacle, wherein said receptacle includes a bottom wall and a perimeter wall being attached to and extending upwardly from the bottom wall, wherein said perimeter wall has an upper edge defining an opening extending into an interior space of the receptacle;
a first set of objects which is thematically linked to the first baking scenario and which fits into the receptacle;
first indicia identifying the first set of objects as being thematically linked to the first baking scenario;
second indicia identifying the first set of objects as being thematically linked to the second baking scenario;
third indicia identifying the first set of objects as being thematically linked to the third baking scenario;
first instructions for using the first set of objects in a way that is pertinent to the first baking scenario, second baking scenario, and the third baking scenario;
wherein one of the first baking scenario, the second baking scenario, and the third baking scenario comprises inducing the one or more users to prepare one or more batches of cookies whereby each of the one or more batches of cookies utilizes one or more different ingredients, and the first set of objects pertains to instruments to facilitate the preparations of the one or more batches of cookies;
wherein the one or more ingredients comprises all-purpose flower, baking powder, baking soda, salt, unsalted butter, salted butter, sugar, eggs, milk, powdered sugar, shortening, brown sugar, vanilla extract, rolled oats, chocolate morsels, and margarine; and,
wherein the first set of objects comprises one or more cookie cutters, one or more temporary tattoos, one or more measuring spoons, one or more aprons, one or more stencils, and one or more spatulas.

2. The novelty kit of claim 1, wherein the first indicia, the second indicia, and the third indicia comprises a recipe pertaining to a type of cookie and preparation instructions for the cookie.

3. A method for teaching one or more users the chemical reactions and physical transformations that occur in the process of preparing and baking cookies by utilizing any one of a plurality of baking scenarios including a first baking scenario, a second baking scenario, and a third baking scenario, comprising:
providing a receptacle, wherein said receptacle includes a bottom wall and a perimeter wall being attached to and extending upwardly from the bottom wall, wherein said perimeter wall has an upper edge defining an opening extending into an interior space of the receptacle;
providing a first set of objects which is thematically linked to the first baking scenario and which fits into the receptacle;
providing first indicia identifying the first set of objects as being thematically linked to the first baking scenario;
providing second indicia identifying the first set of objects as being thematically linked to the second baking scenario;
providing third indicia identifying the first set of objects as being thematically linked to the third baking scenario;
providing first instructions for using the first set of objects in a way that is pertinent to the first baking scenario, second baking scenario, and the third baking scenario;
wherein one of the first baking scenario, the second baking scenario, and the third baking scenario comprises inducing the one or more users to prepare one or more batches of cookies whereby each of the one or more batches of cookies utilizes one or more different ingredients, and the first set of objects pertains to instruments to facilitate the preparations of the one or more batches of cookies;
wherein the one or more ingredients comprises all-purpose flower, baking powder, baking soda, salt, unsalted butter, salted butter, sugar, eggs, milk, powdered sugar, shortening, brown sugar, vanilla extract, rolled oats, chocolate morsels, and margarine; and,
wherein the first set of objects comprises one or more cookie cutters, one or more temporary tattoos, one or more measuring spoons, one or more aprons, one or more stencils, and one or more spatulas.

4. The method of claim 3, wherein the first indicia, the second indicia, and the third indicia comprises a recipe pertaining to a type of cookie and preparation instructions for that type of cookie.
